(19) United States
(12) Patent Application Publication
(10) Pub. No.: US 2004/0102239 A1
(43) Pub. Date: May 27, 2004

(54) Lottery Game

(76) Inventor: Eliyahu Samila, Kfar Yona (IL)

Correspondence Address: DR. MARK FRIEDMAN LTD., C/o Bill Polkinghorn, Discovery Dispatch, 9003 Florin Way, Upper Marlboro, MD, 20772, US

(21) Appl. No.: 10/303,790

(22) Filed: Nov. 26, 2002

(51) Int. Cl. A63F 9/24; A63F 13/00; G06F 17/00; G06F 19/00

(52) U.S. Cl. 463/17

(57) ABSTRACT

A lottery game where the prize money is always distributed. A lottery game based on each participant selecting a subset of values from the set of values followed by the drawing of a winning subset of values is played. A winner or plurality of winners is chosen as the participant or participants each of whose respective subset of values has the highest correlation with the winning subset of values. The prize is subsequently distributed amongst all the winners.

### FIELD OF THE INVENTION

The present invention relates generally to gambling and games of pure chance, and more specifically to a lottery game. The invention provides for equitable distribution of all prizes for a given lottery drawing, increasing the desire to participate.

### BACKGROUND OF THE INVENTION

Lottery games are often operated by private entrepreneurs, by governments, and by government-licensed sub-contractors. One of the most popular methods of gaming, due to simplicity and participant enjoyment, is generally known as a “Lotto” game.

Lotto games involve selection of a winning subset of values from a usually much larger but finite set of values. Each participant is provided with a respective subset of values. Such providing is most commonly done either randomly or by a participant choosing a desired subset of values. Each participant may be allowed to have more than one subset of values. After all participants have been provided with a participant subset of values, a winning subset of values is randomly selected, a process called drawing.

Following the drawing of the winning subset of values the participant subset of values are ranked according to the correlation between the participant subset of values and the winning subset of values. The greater the correlation the higher the ranking. In general, ranking is determined by the degree of correlation of a participant subset of values with the winning subset of values as a function of the statistical likelihood of achieving that correlation. A high correlation is statistically less likely than a low correlation, and is therefore ranked higher. Clearly, a participant subset of values that includes all values of the winning subset of values is the most highly ranked, and results in the respective participant receiving the grand prize (vide infra).

For example, in a typical “simple” Lotto game, ranking is a direct function of the correlation between a given participant subset of values and the winning subset of values. In a game where a winning subset of values is 6 numbers from a set of 50 numbers, a participant subset of values must have 6 numbers identical to the 6 numbers in the winning subset of values to be ranked first (termed 6/6). A participant subset of values must have 5 numbers identical to 5 of the 6 numbers in the winning subset of values (termed 5/6) to be ranked second.

A common variation of a Lotto game is the “additional number” or “plus 1” Lotto. The game is substantially the same as a “simple” Lotto excepting that the winning subset of values includes an additional winning value. The highest ranked participant subset of values is one including values identical to the winning subset of values. The second place ranking is a participant subset of values identical to the winning subset of values excepting one, where the one non-identical value is equivalent to the additional winning value.

For example, in a “plus 1” Lotto game, a winning subset of values is 6 numbers from a set of 50 numbers. In such a game, a participant subset of values must have 6 numbers identical to the 6 numbers in the winning subset of values to be top ranked (termed 6/6). A participant subset of values having 5 numbers identical to 5 of the 6 numbers in the winning subset of values and the 6th number of the participant subset of values identical to an independently determined additional winning number (termed 5+1/6) is ranked in second place.

To win the grand prize (which is usually of qualitatively greater value than all other prizes, if such prizes exist), a participant subset of values must be must be of the highest-ranking possible (that is, identical to the winning, subset of values). If no participant subset of values is eligible for the grand prize (no participant subset of values includes all the values of the winning subset of values) no grand prizewinner is chosen from amongst the participants. The grand prize is usually retained by the organizer and added to the grand prize of a subsequent Lotto drawings.

Lotto game organizers usually make a Lotto game more attractive by designating a certain amount of lesser prizes, usually significantly lower in value than the grand prize, to be distributed to participants whose respective subset of values are lower ranked, that is included some but not all of the values of the winning subset of values. Thus a participant who “almost won” is rewarded with a relatively modest prize so as to ameliorate disappointment and encourage further Lotto participation.

Distribution of lesser prizes is performed based on ranking. To every given ranking is designated, before the drawing, a prize to be won. This is most often a fixed sum (e.g. $10 for every third ranked participant) or a fixed sum to be distributed amongst all participants having the same ranking (e.g. $1000 to be equitably distributed amongst all third ranked participants).

Examples of a simple prior art Lotto game are graphically depicted in FIG. 1.

A result of a Lotto game where each of three participants has been provided with a subset 10, 12 and 14, respectively, of three values from a ten value set (the digits 1 through 10) is depicted in FIG. 1A. The winning subset of values 16 consists of the digits 3, 5 and 9. Since participant subset 12 consists of values identical to those of winning subset of values 16, the participant to which subset 12 has been provided receives the grand prize, $1000.

A result of a Lotto game where each of three participants has been provided with a subset 10, 12 and 14, respectively, of three values from a ten value set (the digits 1 through 10) is depicted in FIG. 1B. The winning subset of values 18 consists of the digits 3, 5 and 8. Since no participant subset of values consists of the same values as those of winning subset of values 18, the grand prize is retained to be distributed in a future game. Since participant subset 12 includes two values which also appear in winning subset of values 18, the participant to which subset 12 has been provided receives a small prize of $10.

Despite the success of the Lotto game, it is always desirable to increase the popularity of such a game. Specifically, it would be advantageous to increase the popularity of the game for “opportunistic” participants: those who have no loyalty to a game or a specific operator, but are rather willing to participate on a one-time, often impulsive, basis. The importance of such participants is especially high for Lotto games managed on computer networks, such as the Internet where opportunistic participants make up a large percentage of participants. Such participants will often be repulsed by the idea that in the case of no winner the grand prize is retained for future distribution.

There is a need for a lottery game, based on the existing Lotto game that increases the attractiveness of the game to opportunistic participants.

### SUMMARY OF THE INVENTION

The above and other objectives are achieved by the method of operating a lottery game provided by the present invention.

According to the teachings of the present invention there is provided a method of operating a lottery game comprising:

a. providing a finite set of values;

b. for each one of a plurality of participants providing a respective participant subset of values;

c. drawing (preferably randomly) a winning subset of values from the finite set of values;

d. ranking each one of the participant subset of values based on a degree of correlation between the winning subset of values and that participant subsets of values;

e. determining as winners all participants whose respective participant subset of values has the highest ranking in the specific drawing; and

f. equitably distributing a prize equitably amongst all winners.

Also according to the teachings of the present invention there is provided a method of operating a lottery game comprising:

a. providing a finite set of values;

b. for each one of a plurality of participants providing a respective participant subset of values;

c. drawing a winning subset of values from the finite said of values;

d. ranking each of the participant subsets of values based on a degree of correlation between the winning subset of values and that participant subset of values;

characterized in that a prize is equitably distributed after each drawing to all participants having a participant subset of values with the highest ranking achieved in that drawing.

According to a feature of the present invention, the lottery is substantially performed on a computer network, such as the Internet. Generally this means that at least one of b, c, d and e is performed on a computer network.

According to a further feature of the present invention, the magnitude of the prize is a function of the number of participants.

### BRIEF DESCRIPTION OF THE DRAWINGS

The invention is herein described, by way of example only, with reference to the accompanying drawings, wherein:

FIG. 1A (prior art) is a schematic depiction of the results of a lottery game where a participant has won the grand prize.

FIG. 1B (prior art) is a schematic depiction of the results of a lottery game where no participant has won the grand prize;

FIG. 2A is a schematic depiction of the results of a lottery game according to the present invention where a participant has won the grand prize;

FIG. 2B is a schematic depiction of the results of a lottery game according to the present invention where a participant has won the grand prize despite not having a winning subset of values; and

FIG. 2C is a schematic depiction of the results of a lottery game according to the present invention where two participants have won the grand prize despite not having a winning subset of values.

### DETAILED DESCRIPTION OF THE INVENTION

The present invention is of a method of operating a lottery game. The principles of the present invention may be better understood with reference to the drawings and description hereinbelow.

In order to encourage opportunistic participants to join a particular lottery it is necessary to ensure that the participant feels that there is a good chance of return on the “investment”. If the participant feels that the grand prize is not going to be distributed in a specific game, the participant will feel that the “investment” is, for all intents and purpose, wasted.

According to the method of the present invention, a grand prize is equitably distributed after every specific drawing. As in prior art Lotto games, the lottery game of the present invention involve selection of a winning subset of values from a larger set of values. Each participant is provided an own participant subset of values. Each participant may be allowed to have more than one subset of values. After all participants have been provided with a respective participant subset of values, a winning subset of values is selected (drawn), preferably randomly. The respective subsets of values of all the participants are compared to the winning subset of values. The participant subsets of values are ranked, as described hereinabove and as known in the art. As stated above, ranking is primarily dependent on the correlation between the winning subset of values and the participant subsets of values.

Once the participant subset of values has been ranked, the winner or winners are determined to be those participants whose respective participant subset of values are the highest ranked in that drawing. For example, if in a given drawing, there are no first or second ranked participant subsets of values, then all participant subset of values that are third ranked are determined to be winners. The grand prize is then equitably distributed amongst the winners.

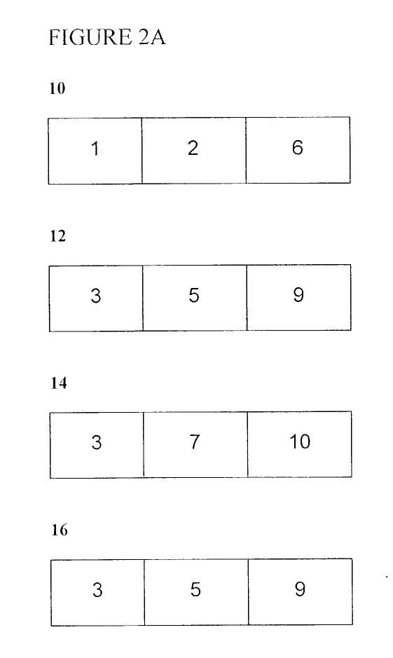

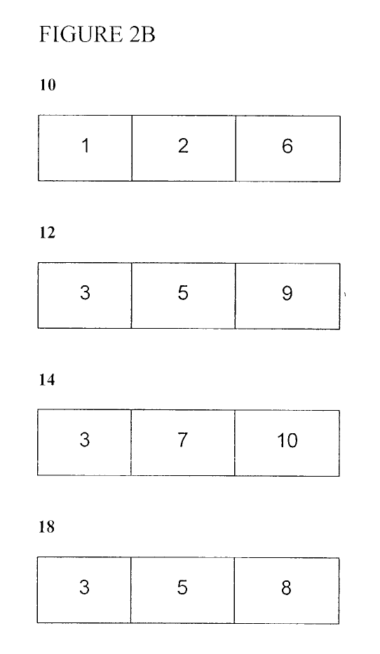

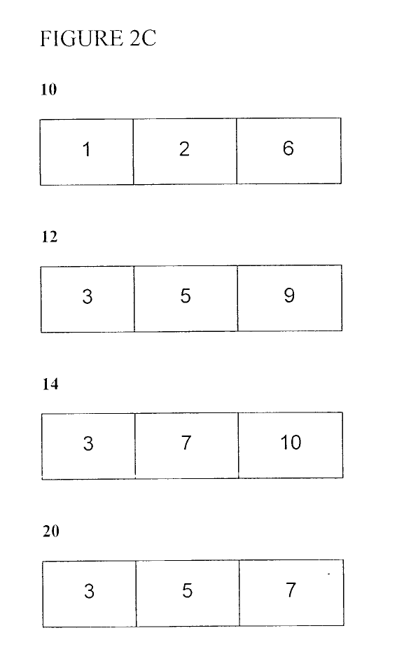

Examples of the method of the present invention are graphically depicted in FIG. 2.

A result of a lottery game according to the present invention where each of three participants has been provided with a subset 10, 12 and 14, respectively, of three values from a ten value set (the digits 1 through 10) is depicted in FIG. 2A. The winning subset of values 16 consists of the digits 3, 5 and 9. Since participant subset 12 consists of values identical to those of winning subset of values 16, the participant to which subset 12 has been provided receives the grand prize, $1000.

A result of a Lotto game where each of three participants has been provided with a subset 10, 12 and 14, respectively, of three values from a ten value set (the digits 1 through 10) is depicted in FIG. 2B. The winning subset of values 18 consists of the digits 3, 5 and 8. No participant subset of values consists of the same values as those of winning subset of values 18. However, participant subset 12 consists of two values identical to those of winning subset of values 18. Participant subset 10 includes no values identical to those of Winning subset values 18. Participant subset 12 includes one value identical to those of winning subset values 18. Thus, the participant to which subset 12 has been provided receives the grand prize, $1000.

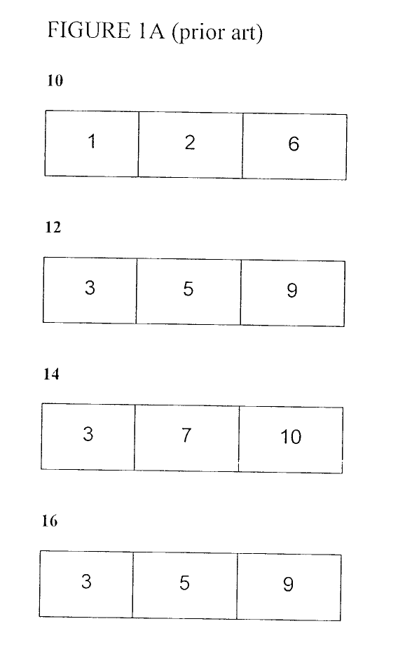

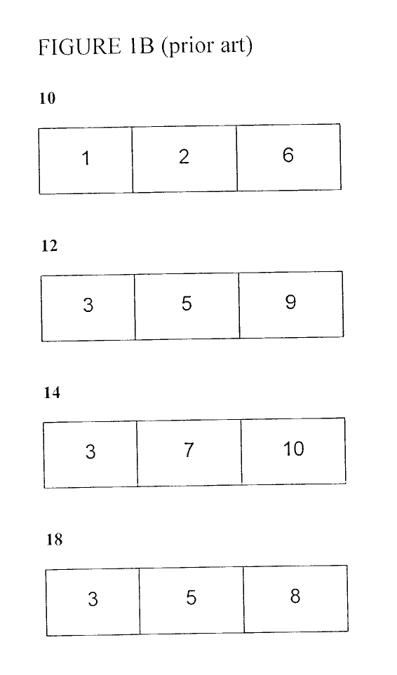

A result of a Lotto game where each of three participants has been provided with a subset 10, 12 and 14, respectively, of three values from a ten value set (the digits 1 through 10) is depicted in FIG. 1C. The winning subset of values 20 consists of the digits 3, 5 and 7. No participant subset of values consists of the same values as those of winning subset of values 20. However, both participant subsets 12 and 14 include two values identical to those of winning subset of values 20. Thus, the participant to which subset 12 has been provided and the participant to which subset 14 has been provided share the grand prize, each receiving $500.

It is clear to one skilled in the art that when applying the method of the present invention distribution of lesser prizes can be optionally retained. In such a case a winner could receive a second prize as well as a share of the grand prize. The method of distributing lesser prizes is substantially similar to the method by which the grand prize is distributed as described hereinabove. As the modifications and changes necessary are clear to one skilled in the art such will not be discussed hereinfurther.

The size of the set of values as well as the size of the participant subset of values or the size of the winning subset of values is immaterial to the functioning of the method of the present invention. Typically (size of subsets of values/size of set of values) known in the art and applicable to the method of the present invention are 6/42 (Ireland). 6/47 (Hong Kong Mk6), 6/49 (Bayern Lottery), 6/50, 6/51 (New York), 6/53, 6/69 and 7/49.

An advantage of the method of the present invention becomes apparent when applied in the field of computer network gambling (e.g. where at least some of the steps of the game occur using a computer network such as the Internet). In geographically localized Lotto games, the number of participants can be accurately estimated so that the size of the set of values as well as the size of the winning subset of values can be chosen so that the statistics of prize distribution is as desired. In contrast in computer network gambling, the number of participants is unpredictable and changes arbitrarily. For example, as is clear to one skilled in the art, a prior art lottery game that has been designed so that there is a good chance of a single participant winning a grand prize from amongst 10⁵ participants will distribute almost no prizes if there are only 10⁴ participants. Such a lottery will be unattractive. In contrast, when the method of the present invention is applied, the participants know that the grand prize will be distributed and will be encouraged to play. Thus the dynamic determination of the ranking required for winning the grand prize renders a lottery game of the present invention exceptionally suitable for a lottery game where the number of participants is unpredictable. Each participant knows that the chances of winning are dependent on the number of participants, and as a result the chance of winning is always reasonable.

Due to the exceptional suitability and attractiveness of the present invention for application using computer networks, in a preferred embodiment of the present invention, the magnitude of the prize or prizes is not determined ahead of time but rather determined by the number of participants. For example, if 100 participants each invests $10, the total prize money is $1000 less costs and operator profits. This is in contrast to prior art Lotto games where the order of magnitude of the prizes, or even the exact prize, is published before the drawing for that lottery is actually performed. The combination of dynamic chances of winning with a dynamic prize value, both functions of the number of participants makes the method of the present invention exceptionally attractive both for participants and for game operators.

The present invention is not limited to the embodiments described herein but encompasses any and all ell embodiments within the scope of the claims.

1. A method of operating a lottery game comprising:
a. providing a finite set of values;
b. for each one of a plurality of participants providing a respective participant subset of values;
c. drawing a winning subset of values from said finite said of values;
d. ranking each of said participant subset of values based on a degree of con-elation between said winning subset of values and said each of said participant subsets of values;
e. determining as winners all participants whose said respective participant subset of values have a highest ranking; and
f. equitably distributing a prize equitably amongst all said winners.

2. The method of claim 1 wherein at least one of the group consisting of b, c, d and e is performed on a computer network.

3. The method of claim 1 wherein the magnitude of said prize is a function of the number of said participants.

4. The method of claim 1 wherein said drawing is random.

5. A method of operating a lottery game comprising
a. providing a finite set of values;
b. for each one of a plurality of participants providing a respective participant subset of values;
c. drawing a winning subset of values from said finite said of values;
d. ranking each of said participant subset of values based on a degree of correlation between said winning subset of values and said each of said participant subsets of values;
characterized in that a prize is equitably distributed after each said drawing to all participants having a participant subset of values with a highest achieved in said drawing.

6. The method of claim 5 wherein at least one of the group consisting of b, c and d is performed on a computer network.

7. The method of claim 5 wherein the magnitude of said prize is a function of the number of said participants.

8. The method of claim 5 wherein said drawing is random.
